(19) United States
(12) Patent Application Publication
(10) Pub. No.: US 2015/0366760 A1
(43) Pub. Date: Dec. 24, 2015

(54) Nasogastric tube anti aspiration device

(71) Applicant: Ibrahim Elali, Surprise, AZ (US)

(72) Inventor: Ibrahim Elali, Surprise, AZ (US)

(21) Appl. No.: 14/120,544

(22) Filed: May 30, 2014

(51) Int. Cl. A61J 15/00

(52) U.S. Cl. CPC A61J 15/0003; A61J 15/0038; A61J 15/0049

(57) ABSTRACT

An anti-aspiration device for a medical tube may comprise of at least one expandable/extendable membrane that once inserted within the cavity of an organ, will abut against interior walls of the cavity of the organ thereby creating a seal to reduce aspiration. One alternate embodiment may comprise of at least two membranes. Another alternate embodiment may comprise of a membrane configured to conform to the boundaries of the interior walls of the cavity of the organ. The device may include sensors and alert system to further enhance the attention towards needed adjustment or removal of the medical tube.

This non-provisional application claims priority from the provisional application, filed May 30, 2013 under Ser. No. 61/829,129.

### BACKGROUND OF THE INVENTION

1. Field of the Invention

The present invention relates to medical tubes, namely nasogastric tubes, and more particularly to a device and a system for decreasing the risk of aspiration or reflux in a patient.

2. General Background and State of the Art

A medical tube (i.e. catheter) is generally a flexible tube used to aspirate fluid from or deliver nutrients or medications to an organ of interest. Medical tubes can be inserted into organs such as the lungs or stomach. When the organ of interest is the stomach the tube may be used for a patient who is unable to eat without intervention, has upper gastrointestinal bleeding, a bowel obstruction or illeus, ingestion of poison, contaminant or a drug overdose, or who requires bowel irrigation. A medical tube may often be used during emergency situations or post abdominal surgery. A medical tube is usually inserted by or under the supervision of a physician. Medical tubes may be inserted surgically such as through the skin and peripheral tissue into the cavity of the target organ, or inserted through nasal passages (e.g. nasogastric) or oral (e.g. orogastric) passages.

In one alternative embodiment, a nasogastric tube is inserted through a patient's nasal passage and extends through the oropharynx, esophagus, and into the stomach or duodenum. Known nasogastric tubes are constructed of generally flexible material, and have one or more separate interior bores or lumina, each extending most of the length of the tube. Plural lumina allow multiple functions, such as introduction of fluids, removal of matter, and ventilation of the region around the end of the tube.

Decompressing the gastric contents is essential to avoid the development of abdominal distention. Abdominal distention can lead to vomiting and aspiration of gastric contents into the lungs that can lead to a serious to fatal complication called aspiration pneumonia. While a nasogastric tube can be used to relieve distention, there is a chance of increased aspiration due to reflux of gastric fluids through the opening at the esophageal gastric sphincter that is created by the tube itself. Causes of reflux that leads to aspiration include presence of the tube in the stomach itself, medications, surgical procedures, neuromuscular problems, seizures, delayed gastric emptying, poor esophageal sphincter tone, rapid rate of medical infusion, and intestinal obstruction.

Consequences of gastrointestinal aspiration into the lungs may cause a range of symptoms from coughing and wheezing to infection, pneumonia, respiratory failure, and even death. In addition to these types of patient suffering, nasogastric tube related injuries also incur significant expense and burden to the patient, family, and the overall health care system.

Other nasogastric tubes with anti-aspiration devices may reduce aspiration, but may cause further risk of injury. Some prior art may involve placing a rigid umbrella and extending the umbrella in the stomach. Some injuries occur when a patient forcibly pulls on the tube causing the extended umbrella to have injurious contact to the esophagogastric junction and stomach lining resulting patient injury or discomfort to the. A device that has the means to reduce the extended dimensions of the anti-aspiration device would minimize such risk of injury to the patient.

Other anti-aspiration devices may also have non-collapsible bulbs or make the tube wider such that this may cause damage to the nasal passage way and the cardiac sphincter. Such devices that are capable of not substantially increasing the diameter the tube would reduce such risk of injury to the patient.

There are many clinical methods that are aimed in preventing gastrointestinal aspiration into the lungs. Some methods involve using small diameter medical tubes. Some include monitoring the placement of the medical tube or gastrointestinal residual volume. Some involve simply repositioning the patient such as raising the head of the patient. Other methods use medications to enhance gastric emptying. Others have attempted to use inflatable cuffs that are designed to block residual fluids from traveling up the esophagus, but the cuffs do not extend into the cavity of the stomach. Other solutions use sumps in plural lumina tubes that pump out residual volumes. Nevertheless, aspiration still persists.

Prevention of aspiration can lower health risks as well as improve the use and ease of medical tubes. There remains a need in the art for an anti aspiration medical tube, and in particular, a nasogastric tube anti aspiration device.

### INVENTION SUMMARY

The present invention is related to blocking the reflux of residual fluids present in a cavity of an organ that if not occluded, reflux would result in the aspiration of such fluids into a cavity of another organ thereby resulting in a range of symptoms from patient discomfort to injury or illness. It is understood that the term “medical tube” is used in a general sense and includes those tubes or catheters having at least one end internal and at least one end external to the body. Examples of medical tubes, but not limited to, are enteric (i.e. gastric) tubes, orogastric tubes, and nasogastric tubes.

The present invention includes a device that is a medical tube that includes a distal end that has on or near the end a reflux blocking device which includes, but is not limited to launchable balloons or membranes that are inserted into the cavity of the organ. The distal end may contain one or more openings between the lumen of the tube and the cavity of the organ. The device may include one or more lumens that extend the length of the device. The proximal end may be connected to an apparatus for aspirating fluids from the cavity of the organ, or to an apparatus for dispensing air/gas pressure, fluids, nutrition, or medication.

In one embodiment, when the device is inserted into the cavity of the stomach, the distal end is inserted into the stomach, past the esophagogastric junction. Once deployed at an appropriate depth, a minimized balloon is launched either mechanically or by pressure that is created from within the lumen of the medical tube from an apparatus connected to the proximal end of the tube. Once the balloon is sufficiently expanded, the balloon provides a force against an adjacent minimized membrane that extends outwardly with a diameter beyond the orifice of the cardiac opening. The membrane acts to occlude any reflux of gastric fluids or matter thereby reducing the risk of aspiration into the lungs.

In an alternative embodiment, a plurality of lumens may be used for either the controlling of the launching of the balloons and/or additional membranes, reducing or increasing distention within the cavity of the organ via a pump or sump, dispensing nutrients or medicine, or monitoring the depth of the insertion of the distal end of the medical tube, the level of residual volume, or the sufficient extension of the balloons and/or membranes.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

These and other features of this invention will be best understood by reference to the following detailed description of a preferred embodiment of the invention, taken in conjunction with the accompanying drawings, in which:

FIG. 1 is a perspective view of the distal portion of a nasogastric tube and anti-aspiration device.

FIG. 2 is cross-sectional view of a nasogastric tube positioned within a stomach and esophagus including the distal portion of FIG. 1.

FIG. 3 is cross-sectional view of alternative embodiment of a nasogastric tube with a compliant anti-aspiration device.

FIG. 4 is a perpendicular view of anti-aspiration device along the longitudinal axis of the medical tube. and

FIG. 5 is a cross-sectional view of the anti-aspiration device of FIG. 4 positioned within a stomach and an additional balloon positioned at the esophagogastric junction.

### DETAILED DESCRIPTION OF THE PREFERRED EMBODIMENTS

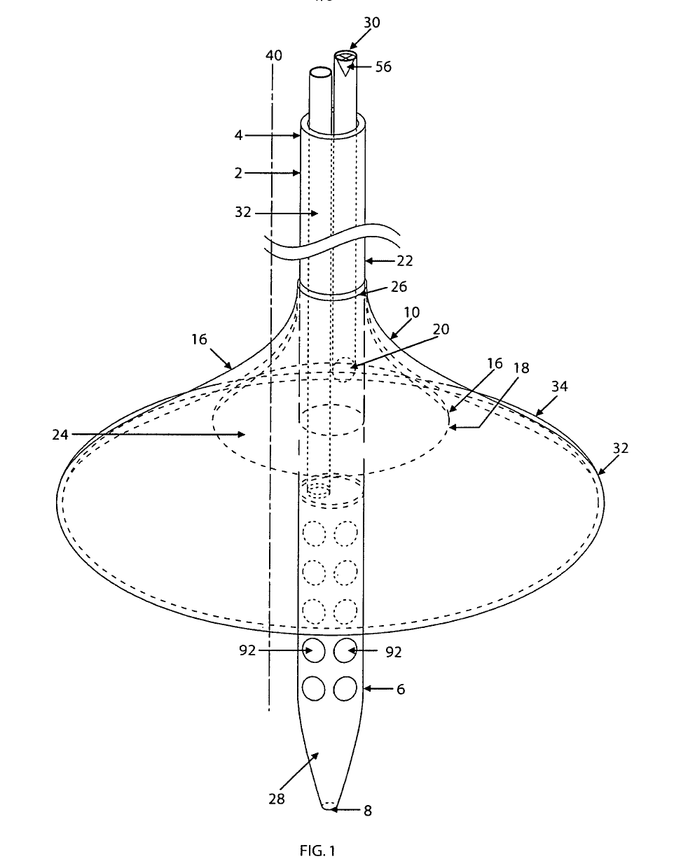

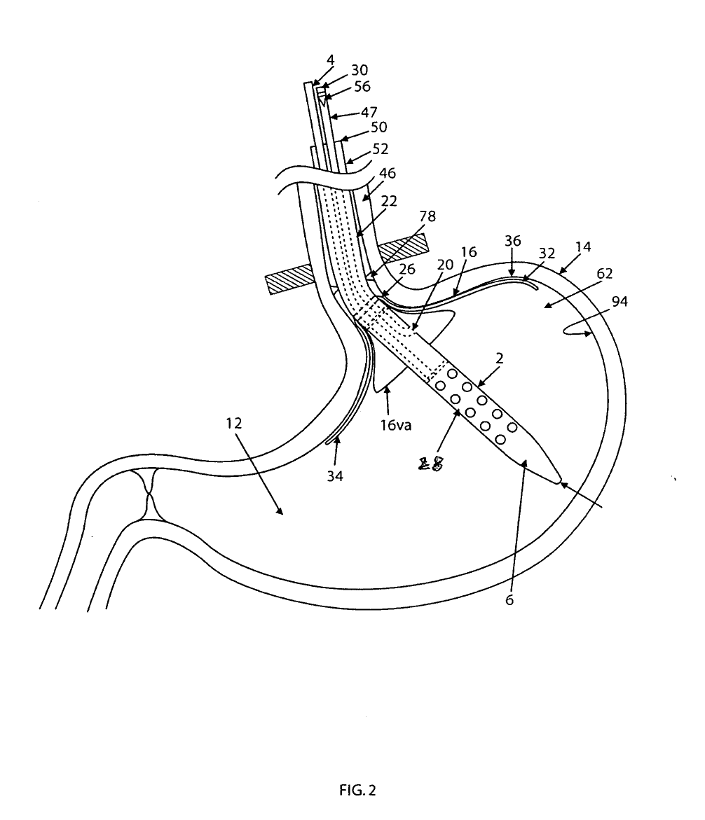

A preferred embodiment of a medical tube anti aspiration system constructed according to the present invention is shown in FIG. 1 and in FIG. 2. A medical tube 2 has a proximal portion 4 and distal portion 6. The distal portion 6 has a distal end 8 that may have a single opening or may be fenestrated. The distal portion 5 may have an anti-aspiration device 10 that may also serve to retain the distal end 8 in the cavity 12 of the organ 14. The anti-aspiration device 10 may comprise of at least one or more membranes 16. The membranes 16 may be extended by the organ's interior cavity pressure which may be produced by the matter within the stomach such as gas, fluids, and solids, within the organ's interior cavity 12 or from the delivery of fluids, gas, nutrients, or medicine delivered into the interior cavity 12 by the medical tube 2. The membranes 16 may be expanded into a balloon 18 by pressure applied by external flow emanating from at least one opening 20 emerging from a central lumen 22 into an enclosed interior space 24 created by the seams 26 of the membrane along the exterior of the distal portion 28. Membranes shall be interpreted to include inflatable or non-inflatable anti-aspiration devices 10 including balloons of a variety of dimensions.

The external pressure provided by a flow of gas or liquid from a source starting at the proximal end 30 and passing to the distal portion 6 of the medical tube 2. The flow may be generated by non-passive means such as the use of a syringe, a peristaltic pump, or other equivalent means, and passive means such as gravity. The flow may travel through at least one opening 20 from a central lumen 22 to the enclosed interior space 24 of the membrane 16, which the central lumen 22 may or may not be dedicated to one particular membrane. There may be a dedicated central lumen 22 to the cavity 32 or other membranes connected to the distal portion 6.

The extended membrane 32 may be connected to the distal portion 6 sufficiently adjacent to the balloon 18 such that the balloon 18 provides sufficient force and support to raise up the extended membrane 32. The extended membrane 32 may be configured to have a diameter greater than the balloon 18, but may also be less in diameter than the balloon's diameter.

The extended membrane 32 may be expandable by pressure or flow and may have a fully enclosed interior space 24, or innervated channels or alternatively inflatable rods wherein the enclosed interior space 24 within either embodiment are connected to an opening 20 to a central lumen 22 that may assist in providing support throughout the extended membrane 32 in order to further extend the membrane 16. (not shown) The enclosed interior space 24 may alternatively be a network of channels similar to veins within a leaf. There may be openings 20 in the membrane 16 present between the channels.

The expandable balloon 18 may also be in the shape of a disc, and one of the disc's wide exterior surfaces may be directly abutted against the one exterior surface of the extendable membrane. (not shown) The disc may also have channels, inflatable rods, or a leaf like network of veins. The disc may be of the same diameter of the extendable membrane 34 or lesser a diameter. The disc may be constructed of more rigid materials than the extendable membrane 34. It is preferred that the extendable membrane 34 be more flexible such that it may conform to the interior boundaries 36 of the cavity 12. The disc may be attached directly to the extendable membrane 34.

One preferred embodiment of the plurality of membranes is that the membranes 16 may have a narrow thickness sufficient for comfortable insertion into the orifice 78 of the cavity 12 of the organ 14. The membranes 16 may be compliant so as to conform to the interior boundaries of the cavity.

The materials for the membranes 16 may be of elastic material such as, but are not limited to, silicone. The materials may also be dissolvable polymer based materials such as, but not limited to, cellulose. The materials may be compliant and flexible to conform not only to the interior walls 38 of the cavity 12, but also the ridges and striations on the surface (i.e. stomach lining) 94 of the interior walls 38. The materials may also be sufficiently rigid to maintain an extended conformation of the membranes 16. The materials may have adhesive properties to allow for stable contact with the interior walls 38 and the ridges and striations therein. However, the materials should be sufficiently compliant so as not to inflict damage to the patient should the device be removed from the cavity 12 inadvertently with sufficient force.

FIG. 2 shows a cross-sectional of the line 40 in FIG. 1 of the medical tube 2 used as a gastric tube 42, and inserted into the stomach 66 through cardiac sphincter 44 and esophagus 46. The anti-aspiration device 10 may be positioned below the diaphragm 90 and cardiac sphincter 33. The medical tube 2 may be enteric. The proximal portion 4 is also shown wherein the portion may be comprised of at least one tube 48. Generally, it is preferred that a plurality of tubes 48 or lumens 50 is collected together to reduce the diameter of the collection of the tubes 48. Alternatively, an external shaft 52 may be used to hold all the tubes/lumina together. The proximal end 54 may allow for the tubes 48 to be separated.

In the embodiment shown, a central lumen 22 may be dedicated to expand the membranes 16. The proximal end 54 of the dedicated central lumen 22 may have a valve 56 to control the flow which such control may expand or minimize the anti-aspiration device 10. The valve 56 may also be closed to hold the pressure within the expandable membranes such as balloon. A pump or syringe may be attached to the valve 56 for applying the external flow needed to keep the membranes expanded/extended or minimized. An approximate volume of air that maybe used to inflate the expandable membranes may be in a range of 20 to 50 cubic centimeters.

The valve 56 may also serve as a release valve of pressure so as to avoid injury when a patient forcibly pulls on the medical tube 2. In such a case, forcible pressure exerted on the expandable membranes would cause back pressure into central lumen 22. The back pressure may be released from the valve 56 if the pressure reaches a certain threshold limit. The expandable membranes may then be deflated in the process. The deflated membranes would reduce or avoid the injury to the patient's stomach lining 94, esophagogastric junction 96, and esophageal lining 98. A band of digestible material may be used to hold the membranes or balloons flush against the exterior 28 of the distal portion. As the membranes 16 inflates or extend the band may be broken or repositioned along the distal portion 28.

The valve 56 may also be used to deflate the expandable membranes prior to inserting the nasogastric tube 42 through the nasal passage. Further, the valve 56 may be connected to a suction device which may maximize the deflation of the expandable membranes. The valve may be a two way valve where when the pressure is sufficiently high, valve may be allowed to temporarily open to release the excess pressure and thus allow the balloon to be vented. When the pressure is sufficiently low, the valve may remain permanently open so long as the pressure is low.

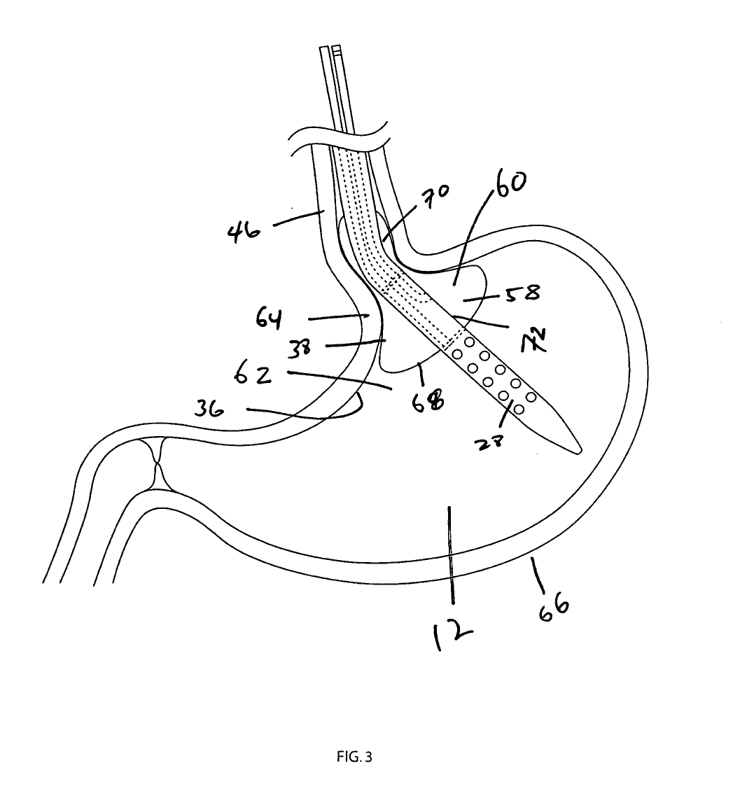

FIG. 3 is an alternative embodiment of a medical tube 2 used as a nasogastric tube 42. The anti-aspiration device 10 may include at least one conforming balloon 58. The conforming balloon 58 may comprise a compliant and flexible material that when abutted against the interior walls 38 of the cavity 12 of the organ 14, conform to the interior boundaries of the cavity 12, i.e. organic balloon 60. The organic balloon 60 of the nasogastric tube 42 may be positioned below the cardiac sphincter 44 and conform to the interior boundaries 36 of the cardia 62.

The organic balloon 60 shape within the stomach 66 may be established by positioning a minimized conforming balloon 58 at a position in the cardia 62 such that the organic balloon 60 expands within the cardia 62 and is thereby held into place by the converging interior walls 64 of the cardia 62. Alternatively, the organic balloon 60 shape may be formed by first expanding the conforming balloon 58 within the stomach 66 at or just below the cardia 62, and pulling the distal portion 6 upwards thereby abutting and compressing the organic balloon 60 against the converging interior walls 64 of the cardia 62. The portion of the organic balloon 60, i.e. distal portion 68 of the organic balloon, is disposed away from the converging interior cardia walls 60 and has a greater diameter than the proximal portion 70 of the organic balloon 60. The flexible conformity of the organic balloon 60 against the converging interior cardia walls 64 provides increased occlusion of the aspiration of fluid.

If the pressure of the organic balloon 64 is too great, the balloon may include easily breakable seams 72 which connect the organic balloon 64 to the exterior of the distal portion 28. The easily breakable seams 72 rupture upon the pressure exceeding a threshold limit. The threshold limit may be established by reducing the thickness of the organic balloon 64 material at the seal junction or by partial perforations along the organic balloon's seams 72. The threshold limit may also be established by using weaker adhesives in attaching the organic balloon 64 to the distal portion. The easily breakable seams 72 may also serve to reduce the chance of injury if the medical tube 2 was inadvertently pulled out with sufficient force to cause injury to the organ 14.

The organic balloon 64 or any other embodiment of the anti-aspirating devices may have radiopaque markings to enable one to monitor by x-ray the location and placement of the anti-aspirating device 10. Other sensors may be used to detect location such as but not limited to endoscopic cameras or ultrasound. Sensors understood and used by those with ordinary skill in the art may be used to detect pressure, temperature, or fluid or gas levels.

The conforming balloon 58 may also be configured in a cone like shaped balloon, i.e. cone balloon, which radially expands outwardly from the shaft 52 of the distal portion 6 (not shown). The apex of the cone balloon, i.e. the proximal portion, when used as an anti-aspiration device on a nasogastric tube is positioned near the cardiac sphincter 44 and the a region near the distal portion of the cone balloon abuts a part of the converging interior cardia walls 64 thereby creating a seal with the converging interior cardia walls 64 that occlude aspiration of fluid from the stomach cavity 12. To ensure a sufficient seal, the nasogastric tube 42 may be pulled upwardly so as to wedge the cone into the converging interior cardia walls 64. Pressure within the cone may be released through the control valve so as to relieve any patient discomfort, prevent of injury due to inadvertent removal, or advertent removal. The base of the cone may be concave and the span beyond the converging interior cardia walls 64 which may aid in retention of the nasogastric tube as well as provide an anti-aspiration function.

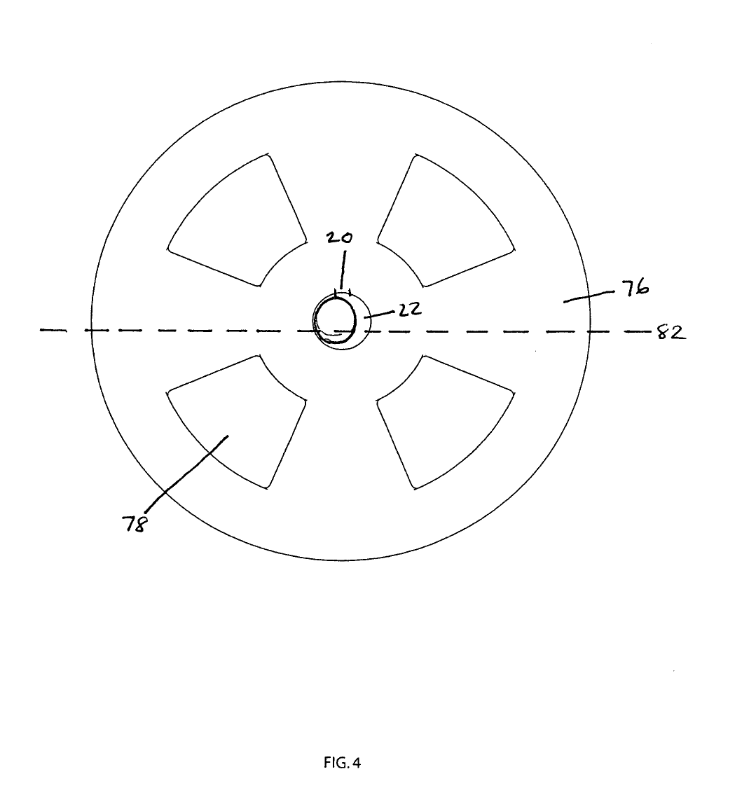

FIG. 4 shows an anti-aspirating device 10 with a ring like shaped balloon, i.e. ring balloon 76. The ring balloon 76 may be connected to channels 78 or alternatively a hollow network of channels that enables flow from an opening 20 to the central lumen 22 to enter and inflate the ring balloon 76 once the distal portion 28 has been inserted into the cavity 12 of an organ 14. The ring balloon 76 may abut against the interior walls of the cavity 12 of an organ 14 to create a seal. The ring balloon 76 may be constructed of flexible material to conform to the interior boundaries 36 of the cavity 12. The ring balloon 76 may be further held in place by the pressure from the stomach 66.

The ring balloon 76 may have an adjacent membrane 16 connected near the ring balloon 76 where the membrane 16 is an extendable membrane 34 and creates the seal with interior walls 38 of the cavity 12 (not shown). One preferred embodiment may have the membrane 16 attached proximally adjacent to the ring balloon 76, relative to the distal portion 28, so as to create a tent like closure in front of the orifice 78 of the cavity 12 and converging interior walls 64. Alternatively, the membrane 16 may be sandwiched between the interior walls 38 and the top surface of the ring balloon 76. Such a membrane 16 may be held in place by the pressure within the stomach 66 against the ring balloon and the reciprocal force created by the interior walls 38. The membrane 16, as with other embodiments that involve anti-aspiration devices 10 may also be partially attached or completely sealed to the ring balloon 76, and the attachment may follow along the outer circumference 80 of the ring balloon 76.

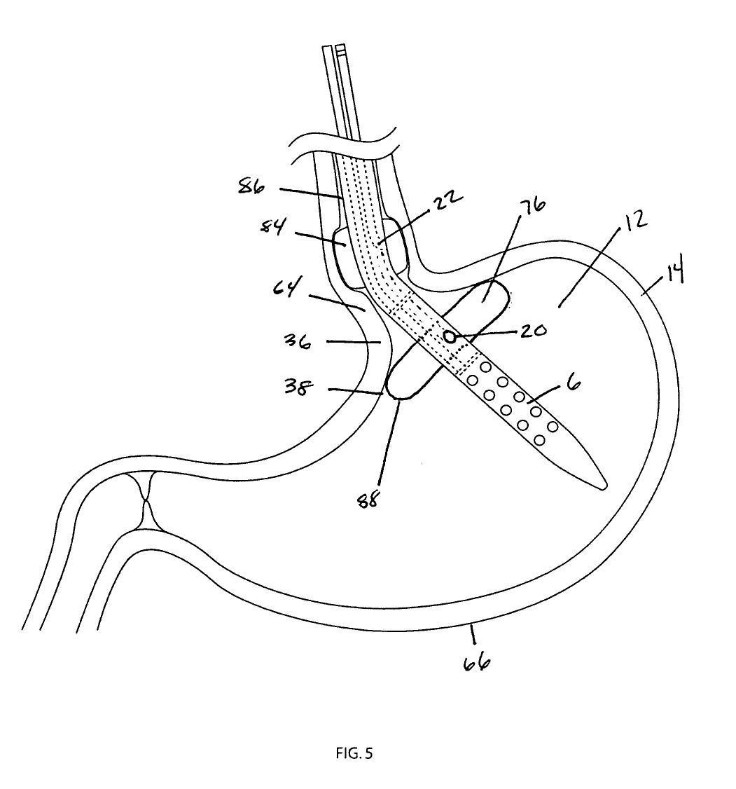

As in FIG. 5, alternatively, the cross-section of the ring as shown in FIG. 4 line 82 may be used in combination with an additional balloon 84 where the additional balloon 84 may be positioned at the orifice 78 of the cavity 12, or on the exterior space 86 of the organ 14 where the additional balloon 84 is configured to fit within the interior boundaries 36 of the exterior space 86 of the organ 14. The additional balloon 84 may be used in combination with a plurality of other membranes 16. The additional balloon 84 may be used to provide further occlusion of aspiration. The additional balloon 84 may also be initially inflated before inflating the more distal membrane(s) 88. The initial inflating may aid in positioning the distal portion 6 and distal membranes 88 prior to expanding or extending said distal membranes 88.

The anti-aspiration devices 10 may also be combined with an alert system connected to sensors that monitor the location and conditions of the anti-aspiration device. The alert system my immediately notify the caretaker or patient of a potentially unsafe positioning of the medical tube 2 or aspiration/reflux which may allow medical personnel to adjust or remove the medical tube 2 efficiently, thereby reducing the chance of patient discomfort or injury.

While the specification describes particular embodiments of the present invention, those of ordinary skill can devise variations of the present invention without departing from the inventive concept.

We claim:

1. A medical tube for allowing flow through a cavity of an organ comprising,
a. A proximal portion, a distal portion, and at least one central lumen extending through the proximal portion and distal portion;
b. Said distal portion being inserted through an orifice of the organ with the end of said distal portion placed within the cavity of the organ, wherein the cavity has interior walls;
c. Said distal portion having at least two membranes, said two membranes connecting to the exterior of said distal portion;
d. At least one of said membranes being expandable and having an enclosed interior space between the interior surface of the expandable membrane and the exterior surface of said distal portion;
e. The location of the connection between said distal portion and said expandable membrane having a least one opening for flow between at least one central lumen and said enclosed interior space of said expandable membrane, and the flow emanating from said central lumen through the opening to the enclosed interior space applying pressure on said expandable membrane whereby said expandable membrane increases in volume and diameter outwardly from said distal portion;
f. Said expandable membrane when at least partially expanded providing at least some support in to extend the other membrane;
g. Said extended other membrane moving outwardly from said distal portion wherein the extendable membrane extends radially from said distal portion;
h. Whereby said expandable membrane and said other membrane significantly occludes aspiration of matter from said cavity.

2. The device of claim 1, wherein said medical tube has at least two central lumens passing through said proximal portion and said distal portion, only one of which ends with at least one opening to said interior space of said expandable membrane, the other central lumen ending with at least one opening near the end of said distal portion.

3. The device in claim 1, wherein said expandable membrane expands to an oblong like shape.

4. The device in claim 1, wherein said expandable membrane expands to a disc like shape.

5. The device in claim 1, wherein said extendable membrane extends to the shape of a disc, whereby the extended disc abuts against said interior walls of said cavity.

6. The device in claim 1, wherein said expandable membrane includes a ring balloon and at least one expandable channel, said channel connecting to the interior space of said ring and to the opening of said central lumen wherein flow emanating from the opening of said central lumen applies pressure that expands the interior space of said channel and said ring balloon.

7. The device in claim 1, wherein said other membrane is expandable, said other membrane including an enclosed interior space between said membrane and the exterior of said distal portion, at least one opening for flow between at least one central lumen and said enclosed interior space of said other membrane, and the flow from said central lumen through said opening to the enclosed interior space of said other membrane applying pressure on interior walls of said other membrane causing said other membrane to extend outwardly from said distal portion.

8. The device in claim 1, wherein the medical tube is a nasogastric tube, and said nasogastric tube includes an additional balloon, wherein the at least two membranes are placed within the cavity of the stomach, and said additional balloon is connected to the exterior distal portion at a location further away from the location of said two membranes relative to said distal portion's end, and said additional balloon is placed at a location wherein said additional balloon significantly occludes further aspiration of matter from the cavity of the organ.

9. A medical tube for allowing flow through a cavity of an organ comprising,
a. A proximal portion, a distal portion, and at least one central lumen extending through the proximal portion and distal portion;
b. Said distal portion being inserted through an orifice of the organ with the end of said distal portion placed within the cavity of the organ wherein the cavity has interior walls;
c. Said distal portion having at least one membrane and the membrane connecting to the exterior of said distal portion;
d. Said membrane being expandable and having an enclosed interior space between the interior surface of said expandable membrane and the exterior surface of said distal portion;
e. The location of the connection between said distal portion and said expandable membrane having a least one opening for flow between at least one central lumen and said enclosed interior space of expandable said membrane whereby said flow emanating from the central lumen through the opening to said enclosed interior space applying pressure on said expandable membrane wherein said expandable membrane increases in volume and diameter radially from said distal portion;
f. Said expandable membrane when sufficiently expanded to form a balloon wherein the balloon has a proximal portion abutting against said interior walls of said cavity and the proximal portion configured to conform to the dimensions of said interior walls whereby said interior walls converge towards said orifice of the cavity;
g. Wherein said expanded balloon has a distal portion projecting into the space of the cavity and said distal portion of said expanded balloon having a wider diameter than said proximal portion of said expanded balloon;
h. Whereby said expanded balloon significantly occludes against the aspiration of matter from said cavity.

10. The device in claim 9 wherein the medical tube is a nasogastric tube, and said expandable balloon has a conical like shape wherein the said conical balloon abuts against the converging interior walls of the cavity of the organ, wherein the organ is a cavity, and the cavity is the cardia of the stomach.

11. The device in claim 9 wherein said balloon comprises compliant material, and said compliant balloon may conform its shape to such that one end of the balloon fits within the converging interior walls of the cavity of the organ.

12. The device in claim 9 wherein said balloon comprises radiopaque markings for monitoring the state of said membranes.

13. The device in claim 9 wherein said balloon is detachable from said distal portion when said balloon is overinflated to a volume that leads to patient discomfort or injury.

14. A medial tube system for delivering flow into a cavity of an organ with the following steps of:
a. Inserting a medical tube into an orifice of a cavity of an organ, said cavity having interior walls forming a three dimensional interior boundary within the cavity, and an exterior space outside the organ near the orifice to the cavity having a space with a three dimensional exterior boundary;
b. Placing a medical tube within said cavity wherein said medical tube comprises a proximal portion and a distal portion, and the proximal portion is located in the exterior space, and the distal portion is located in the interior space, and said distal portion comprising at least one anti-aspiration device on said distal portion, and said anti aspiration device is substantially flush against the exterior of said distal portion;
c. Positioning at least one of said anti-aspiration device within said cavity and near the orifice of the cavity such that it may sufficiently occlude aspiration of matter from the cavity, wherein anti-aspiration device comprises of at least two membranes and at least two central lumens that extends through said proximal portion and said distal portion, wherein at least one central lumen provides flow into the enclosed interior space of at least one of said two membranes;
d. Expanding one of the two said membranes positioned in the cavity by applying external pressure through said central lumen providing flow into said membrane, and membrane is expanded and abuts against the other membrane positioned in the cavity causing the other membrane to extend outwardly from the distal portion;
e. Retaining the distal portion within the cavity and occluding aspiration of fluid from the cavity through said orifice by a sufficient expansion of said expanded membrane and extension of the said other membrane wherein one of the two membranes abuts the interior walls of the cavity on or near the orifice;
f. Delivering flow into the cavity through at least one of the said central lumens that does not feed into the membranes, but only into the cavity.

15. The method of claim 14 wherein said expanding step is accomplished by expanding at least two membranes positioned in the cavity and the membranes expandable by applying external pressure through at least one of the central lumens that feed into an enclosed interior space of the expandable membranes.

16. The method of claim 15 wherein said positioning step further includes one of the at least two expandable membranes being expanded first for positioning the second expandable membrane, and then expanding the second expandable membrane such that the second expandable membrane significantly abuts against the interior boundary of the cavity.

17. The method of claim 14 wherein said positioning step is accomplished by the at least two expanded and extended membranes being positioned to conform to the interior boundary within the cavity that is near said orifice.

18. The method of claim 14 wherein said positioning step also requires the positioning of an additional membrane that when expanded is a balloon, and said additional membrane is connected to the medical tube with its location outside the cavity, and said additional membrane is configured to conform to the exterior boundary on or near the orifice, and said expanded additional membrane further positions the medical tube and occludes aspiration of fluid from the cavity through said orifice.

19. The method of claim 14 wherein after said retaining and occluding step or after said delivering step, a reducing step of pressure to deflate and reduce extension of the membranes for the purposes of distal portion adjustment within the cavity or removal from the cavity.

20. The method of claim 14 wherein an additional step comprising of a monitoring step wherein the distal portion has sensors and an alert system that monitoring of the positioning of the anti-aspiration device relative to said interior and exterior boundaries.
